(19) United States
(12) Patent Application Publication
(10) Pub. No.: US 2004/0110438 A1
(43) Pub. Date: Jun. 10, 2004

(54) Acoustic articles utilizing isocyanate binders and methods of making same

(76) Inventors: Graham Tompson, Northville, MI (US); Surendra Khambete, West Bloomfield, MI (US); Girma Gebreselassie, Southfield, MI (US); Anthony Messina, Royal Oak, MI (US)

Correspondence Address: MYERS BIGEL SIBLEY & SAJOVEC, PO BOX 37428, RALEIGH, NC, 27627, US

(21) Appl. No.: 10/315,711

(22) Filed: Dec. 10, 2002

(51) Int. Cl. B32B 27/12; B32B 5/26; B32B 15/14; B32B 5/02; B32B 27/04

(52) U.S. Cl. 442/43

(57) ABSTRACT

Acoustical panels and methods of making acoustical panels are provided. Isocyanate binder and scrap material are blended together to produce a mixture of recycled material. The mixture of recycled material is formed into a panel, molded to form an acoustic article having a three dimensional contour, and cured via steam. The acoustic article is subjected to trimming operations, and one or more surfaces of the acoustic article may be covered with one or more layers of material. Scrap material generated by the trimming operations are then returned to for reuse.

### FIELD OF THE INVENTION

The present invention relates generally to vehicles and, more particularly, to acoustic articles utilized in vehicles.

### BACKGROUND OF THE INVENTION

It is generally considered desirable to reduce the level of noise within a vehicle passenger compartment. External noises, such as road noise, engine noise, vibrations, etc., as well as noises emanating from within passenger compartments, may be attenuated through the use of various acoustical materials. Accordingly, sound attenuating materials for vehicles, such as automobiles, are conventionally used in the dashboard, in conjunction with carpeting for floor panels, in the wheel wells, in the trunk compartment, under the hood, and as part of the headliner.

The attenuation of external noise is conventionally referred to as sound transmission loss (STL). The attenuation of internal noise is conventionally referred to as sound absorption. The acoustic impedance of a material is defined as material density times acoustic velocity, and is expressed in units of Rayls (Newton-seconds/meter³). Acoustic impedance defines how easy it is for air to move through a material. Thus, for fibrous materials, acoustic impedance depends upon the density of the fibrous material and fiber diameter. Generally, the heavier the blanket and the finer the fibers, the higher the acoustic impedance. Moreover, thicker layers typically have more acoustic impedance than thin layers. The ability of a material to attenuate noise is conventionally defined by the material's STL, acoustic impedance, and absorption characteristics.

Conventional insulation materials utilized by the automotive industry include a mixture of fibrous materials (natural and/or synthetic fibers) held together by a phenolic resin binder. These insulation materials are typically formed via a mold into three-dimensional is shapes to conform with the contours of a portion of a vehicle to which they are to be attached.

Unfortunately, insulation materials utilizing phenolic resin binders may produce unpleasant odors, may cause fogging, and may cause illness and allergic reactions. Moreover, there are environmental concerns associated with producing insulation materials utilizing phenolic resin binders. Substances which may have some level of toxicity (e.g., formaldehyde, ammonia, phenol, etc.) may be released by incomplete crosslinking of phenolic resin binders during manufacturing.

### SUMMARY OF THE INVENTION

In view of the above discussion, embodiments of the present invention include acoustic articles and methods of making acoustic articles that produce no unpleasant odors, that do not cause fogging, that reduce the likelihood of illnesses and allergic reaction, and that are economical to produce. Methods of producing acoustic articles according to embodiments of the present invention include blending isocyanate binder with scrap material, forming the mixture of isocyanate binder and scrap material into a flat panel or other substrate-like shape that facilitates subsequent molding thereof, molding the panel to form an acoustic article having a desired shape, and curing via the application of steam. The acoustic article may be subjected to trimming operations, and then one or more surfaces of the acoustic article may be covered with one or more layers of material (e.g., carpet, scrim, etc.). Scrap material generated by the trimming operations are then returned for reuse.

### BRIEF DESCRIPTION OF THE DRAWINGS

The accompanying drawings, which form a part of the specification, illustrate key embodiments of the present invention. The drawings and description together serve to fully explain the invention.

FIG. 1 is a flowchart of operations for producing acoustic articles according to embodiments of the present invention.

FIG. 2 is a cross-sectional view of an acoustic article according to embodiments of the present invention.

FIG. 3 is a flowchart of operations for producing acoustic articles according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like when used herein are for the purpose of explanation only.

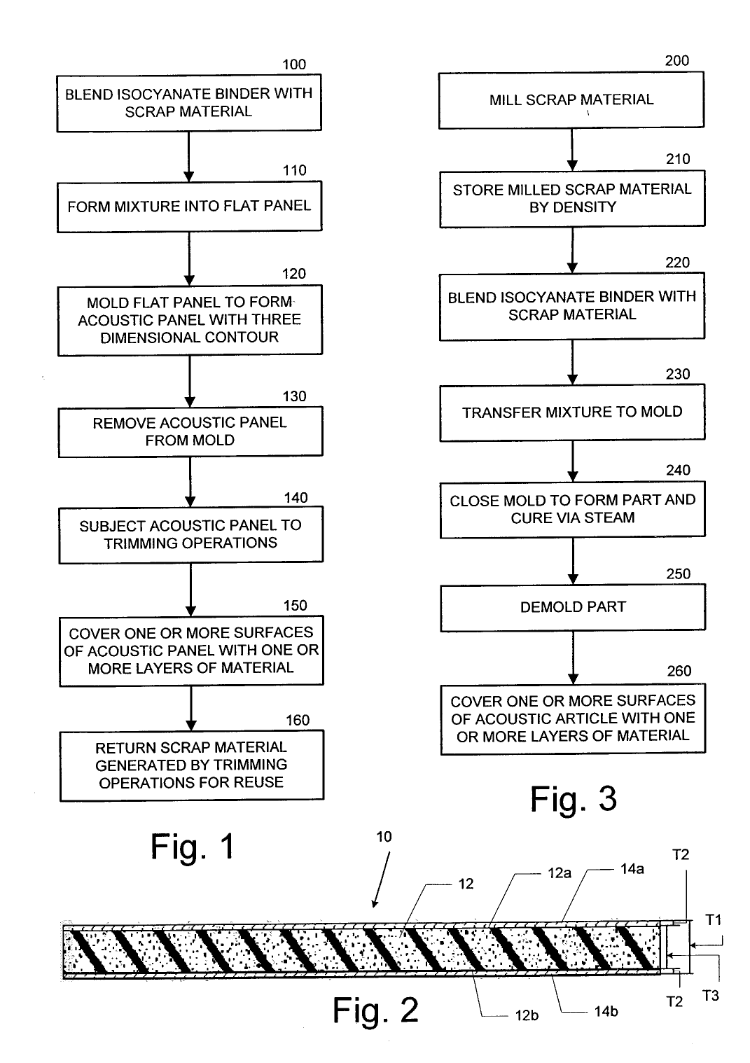

Embodiments of the present invention provide acoustic articles and methods of making same that produce little no unpleasant odors, that reduce the likelihood of illnesses and allergic reaction, and that are economical to produce. Referring to FIG. 1, methods of producing acoustic articles according to embodiments of the present invention include blending isocyanate binder with scrap fiber and/or foam material (Block 100). Exemplary fiber scrap materials including, but not limited to, cotton shoddy, recycled carpet scrap and natural fiber materials may be utilized, and exemplary foam scrap materials including, but not limited to, polyurethane foam, polypropylene foam and polyethylene foam may be utilized. In addition, various combinations of foam scrap and fiber scrap may be utilized.

Carpet scrap that can be utilized as fiber scrap includes automotive carpet scrap, as well as carpet waste generated during residential and non-residential building construction and renovation. Exemplary carpet scrap compositions include, but are not limited to, nylon 6, or nylon 6.6, polypropylene, polyethylene, polyester (e.g., polyethylene terephthalate (PET)), ethylene vinyl acetate (EVA), and filled EVA.

An exemplary mixture includes approximately 80%-95% scrap material by weight and 5%-20% isocyanate binder by weight. According to embodiments of the present invention, the isocyanate binder with scrap material are blended for a predetermined period of time (e.g., between about one and two minutes).

Exemplary isocyanates that may be utilized as a binder include, but are not limited to, aromatic polyisocyanates such as diphenylmethane diisocyanate (MDI), polymethylene polyphenyl isocyanate (polymeric MDI), tolylene diisocyanate (TDI), and naphthalene diisocyanate; aliphatic isocyanates or polyisocyanates such as hexamethylene diisocyanate (HDI) and lysine methyl ester diisocyanate; and alicyclic isocyanates or polyisocyanates such as hydrogenated phenylmethane diisocyanate, isophorone diisocyanate, norbornene diisocyanate, and hydrogenated tolylene diisocyanate.

Other binder materials may be utilized in addition or in combination, according to other embodiments of the present invention. For example, polyurethane and polyurea binder materials may be utilized.

The mixture is then formed into a generally flat panel (Block 110). According to embodiments of the present invention, this may be achieved by dispensing the mixture onto a platen (e.g., a conveyor belt, etc.) and subjecting the mixture to elevated heat for a period of time sufficient to effect at least a partial curing of the isocyanate binder such that the scrap material of the mixture is bonded together into an integral mass.

The flat panel is then placed within a mold and subjected to elevated pressure for a predetermined period of time (e.g., 0.5 min-3 min.) to form the flat panel into an acoustic article having a desired shape (Block 120). An exemplary range of mold pressures, according to embodiments of the present invention, is between about 100 tons and 150 tons. According to embodiments of the present invention, the flat panel may be molded under elevated temperatures. Exemplary mold temperatures may range between about 270° F. and 320° F., although other temperature ranges may be utilized. The resulting molded acoustic article is configured to conform to the corresponding contour of a vehicle to which the acoustic article is to be attached. The acoustic article may be subjected to steam to facilitate curing of the isocyanate binder. Steam may be applied during molding operations or after molding operations. Steam curing may last from about 30 seconds to about 180 seconds, although other curing times are possible. Steam utilized in curing may be a wet steam and may have a temperature range of between about 212 F and about 250, although other steam temperatures are possible, without limitation. Steam pressure may be between about 80 psi and about 120 psi, although other steam pressures are possible, without limitation.

The acoustic article is then removed from the mold (Block 130), subjected to trimming operations (Block 140), and then one or more surfaces of the acoustic article are covered with one or more layers of material (Block 150). Scrap material generated by the trimming operations are then returned for reuse (Block 160).

According to embodiments of the present invention, various layers of material may be attached to one or more surfaces, or to one or more portions of a surface of an acoustic article. For example, carpeting may be attached to one surface (or a portion thereof). Scrim may be attached to one or more surfaces (or portions thereof). Various operations represented by respective blocks of FIG. 1 may be performed out of the illustrated order or substantially simultaneously. For example, trimming operations (Block 140) may be performed prior to removing the acoustic article from the mold (Block 130) or substantially simultaneously.

Referring to FIG. 2, an acoustic article 10, according to embodiments of the present invention, is illustrated. The illustrated acoustic article 10 includes a layer of recycled material 12 having opposite first and second surfaces 12a, 12b, and layers of material 14a, 14b attached to the first and second surfaces, respectively, in contacting, face-to-face relationship.

The layer of recycled material 12 is formed from scrap material and a binder (e.g., isocyanate, polyurethane, polyurea, etc.). The scrap material may include fiber scrap material, foam scrap material, or a combination of fiber and foam scrap material. An exemplary layer of recycled material 12 contains approximately 85%-95% scrap fiber and/or foam material by weight and 5%-15% isocyanate binder by weight.

Acoustic articles according to embodiments of the present invention may have various thicknesses and dimensions. Moreover, dimensions and thicknesses may vary throughout an acoustic article. The illustrated acoustic article 10 has an overall thickness T₁; each layer of material 14a, 14b has a thickness T₂; and the layer of recycled material 12 has a thickness T₃. An exemplary range for T₁ is between about 5 mm and about 30 mm. An exemplary range for T₂ is between about 0.1 mm and about 2 mm. An exemplary range for T₃ is between about 5 mm and about 30 mm.

The layers of material 14a, 14b may be carpeting, scrim, or virtually any other material. In the illustrated embodiment, the layers of material 14a, 14b are scrim. The term “scrim” refers to a skin of coarse fabric (e.g., a fabric made of PET fibers, etc.). Exemplary scrim materials include, but are not limited to, polypropylene, polyethylene, polyester, polyvinyl chloride and the like.

Referring to FIG. 3, methods of producing acoustic articles according to embodiments of the present invention are illustrated. Scrap material such as scrap fiber and/or foam material is milled via a knife mill or other milling device to achieve uniformity in the scrap material (Block 200). Milled scrap material may be stored for later use based upon density (e.g., low, medium, high density, etc.) of the scrap material (Block 210). Milled scrap material is blended with isocyanate binder (Block 220). The type of scrap material and/or the density of scrap material depends on the type of acoustic article to be produced. Moreover, multiple types of scrap material and/or scrap material of various densities may be utilized. The amount of isocyanate binder blended with the scrap material also depends on the acoustic article to be produced. For example, a blend of scrap material and isocyanate binder may be about 90% scrap material (by weight) and about 10% isocyanate binder (by weight). However, embodiments of the present invention are not limited to such 90%-10% blends. Various blends of scrap material and isocyanate binder may be utilized without limitation. According to one embodiment of the present invention, isocyanate binder is sprayed or dispensed into the scrap material to substantially evenly coat individual scrap material pieces.

The blended mixture of scrap material and isocyanate binder is then transferred to a mold (Block 230). The mold is closed, pressure is applied to form the acoustic article, and curing is accomplished via the application of steam (Block 240). Steam curing may last from about 30 seconds to about 180 seconds, although other curing times are possible. Steam utilized in curing may be a wet steam and may have a temperature range of between about 212 F and about 250, although other steam temperatures are possible, without limitation. Steam pressure may be between about 80 psi and about 120 psi, although other steam pressures are possible, without limitation.

The acoustic article is then removed from the mold (Block 250) and may be subjected to other operations, such as trimming, etc. One or more surfaces of the acoustic article may be covered with one or more layers of material (Block 260) as described above with respect to FIGS. 1-2.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of producing an acoustic article, comprising:
blending isocyanate binder with scrap material to produce a mixture;
forming the mixture into a flat panel, comprising subjecting the mixture to elevated heat for a period of time sufficient to effect at least a partial curing of the isocyanate binder to bond the scrap material of the mixture together into an integral mass;
compressing the flat panel in a three dimensional mold to form an acoustic article having a three dimensional contour; and
removing the acoustic article from the mold.

2. The method of claim 1, wherein the mixture comprises approximately 80%-95% scrap material by weight and 5%-20% isocyanate binder by weight.

3. The method of claim 1, further comprising subjecting the acoustic article to trimming operations after the removing step.

4. The method of claim 3, wherein scrap material from the trimming operations is blended with isocyanate binder to produce a second mixture.

5. The method of claim 1, wherein the scrap material comprises scrap fibrous materials selected from the group consisting of cotton shoddy, recycled carpet scrap and natural fiber materials.

6. The method of claim 1, wherein the scrap material comprises scrap foam materials selected from the group consisting of polyurethane foam, polypropylene foam and polyethylene foam.

7. The method of claim 1, wherein the scrap material comprises scrap fibrous materials selected from the group consisting of cotton shoddy, recycled carpet scrap and natural fiber materials, and scrap foam materials selected from the group consisting of polyurethane foam, polypropylene foam and polyethylene foam.

8. The method of claim 1, wherein blending is performed for between about one and two minutes.

9. The method of claim 1, wherein forming the mixture into a flat panel comprises dispensing the mixture onto a platen.

10. The method of claim 1, wherein mold temperature and pressure during the compressing step is between about 270° F. and 320° F., and 100 tons and 150 tons, respectively.

11. The method of claim 1, wherein the molded acoustic article is subjected to steam to cure the isocyanate binder.

12. The method of claim 1, wherein the acoustic article has a contoured surface, and further comprising applying a layer of material to the contoured surface.

13. The method of claim 12, wherein the layer of material is carpeting.

14. The method of claim 12, wherein the layer of material is scrim.

15. The method of claim 1, wherein the acoustic article has opposite first and second surfaces, and further comprising applying a respective layer of material to each surface.

16. The method of claim 15, wherein each respective layer of material comprises scrim.

17. A method of producing an acoustical panel for vehicular use, comprising:
blending isocyanate binder with scrap material within a vessel to produce a mixture of approximately 80%-95% scrap material by weight and 5%-20% isocyanate binder by weight, wherein the scrap material comprises material selected from the group consisting of fiber scrap and foam scrap;
forming the mixture into a flat panel, comprising dispensing the mixture onto a platen and subjecting the mixture to elevated heat for a period of time sufficient to effect at least a partial curing of the isocyanate binder to bond the scrap material of the mixture together into an integral mass;
compressing the flat panel in a three dimensional mold to form an acoustic article having a three dimensional contour;
removing the acoustic article from the mold;
subjecting the acoustical panel to trimming operations after the removing step; and
directing scrap material generated by the trimming operations to the vessel.

18. The method of claim 17, wherein blending is performed for between about one and two minutes.

19. The method of claim 17, wherein mold temperature and pressure during the compressing step is between about 270° F. and 320° F., and 100 tons and 150 tons, respectively.

20. The method of claim 17, wherein the acoustic article has a contoured surface, and further comprising applying a layer of material to the contoured surface.

21. The method of claim 20, wherein the layer of material is carpeting.

22. The method of claim 20, wherein the layer of material is scrim.

23. The method of claim 17, wherein the acoustic article has opposite first and second surfaces, and further comprising applying a respective layer of material to each surface.

24. The method of claim 23, wherein each respective layer of material comprises scrim.

25. The method of claim 17, wherein the molded acoustic article is subjected to steam to cure the isocyanate binder.

26. An acoustic article, comprising:
a layer of recycled material having approximately 80%-95% scrap material by weight and 5%-20% isocyanate binder by weight, wherein the scrap material comprises material selected from the group consisting of fiber scrap and foam scrap; and
a layer of material attached to the layer of recycled material in contacting face-to-face relationship.

27. The acoustic article of claim 26, wherein the layer of material has a thickness of between about 5 mm and 30 mm.

28. The acoustic article of claim 26, wherein the layer of material is carpeting.

29. The acoustic article of claim 26, wherein the layer of material is scrim.

30. The acoustic article of claim 26, wherein the acoustic article has opposite first and second surfaces, and further comprising a respective layer of material attached to each surface in contacting face-to-face relationship.

31. The acoustic article of claim 30, wherein each respective layer of material comprises scrim.
